(19) United States
(12) Patent Application Publication
(10) Pub. No.: US 2011/0120274 A1
(43) Pub. Date: May 26, 2011

(54) THROUGH TYPE SLEEVE

(76) Inventor: Jui-Min HUANG, Taichung City (TW)

(21) Appl. No.: 12/626,368

(22) Filed: Nov. 25, 2009

(51) Int. Cl. B25B 13/06

(52) U.S. Cl. 81/121.1

(57) ABSTRACT

A through-type sleeve has a tubular main body having an actuating end, a wrench sleeving end and an axial through-hole is set at the center of the main body. A moulded groove is set at one end of the through-hole correspondingly to the actuating end, and a round groove set at the other end of the axial through-hole correspondingly to the wrench sleeving end. A blind chamber is recessed radially at one side of the wrench sleeving end of the main body, and provided with an inner wall. An elastic support is accommodated into the blind chamber. A shelled convex locator is assembled externally onto the elastic support and is provided with an inner face supported elastically by the elastic support. A convex surface on the shelled convex locator is protruded outside of the blind chamber, and the protruding state is limited by a limiting portion of the blind chamber.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a sleeve, and more particularly to an innovative through-type sleeve.

2. Description of Related Art Including Information Disclosed Under 37 CFR 1.97 and 37 CFR 1.98.

The difference between the through-type sleeve of the present invention and a conventional one lies in the central axial through-hole in response to different applications.

The through-type sleeve is structurally configured in such a way that one end for sleeving the wrench is generally equipped with an elastic positioning mechanism for avoiding disengagement. The most conventional elastic positioning mechanism is configured in a manner that one end of the through-type sleeve for sleeving the wrench is generally fitted with a radial through-hole, into which a bead is placed. Then, a C-shaped clip is embedded into the inner wall of the axial through-hole at one end of the through-type sleeve, so the bead is flexibly supported outwards, and its exterior is protruded flexibly from the external wall of the through-type sleeve. However, it is observed during actual applications that, this C-shaped clip is fabricated at a higher cost, and a recessed ring groove must be reprocessed onto the inner wall of the axial through-hole of the through-type sleeve for assembly and positioning of the C-shaped clip, leading to great increase of fabrication cost of the through-type sleeve without improvement of the functionality.

Secondly, some problems and limitations are encountered in the industry if the elastic positioning mechanism of the aforementioned through-type sleeve is scheduled to be changed structurally. This is because the specifications of the through-type sleeve and relative proportions of various parts shall be subject to the relevant regulations (e.g. DIN), of which the external diameter of the through-type sleeve for sleeving the wrench (usually outer-hexagonal) and the aperture of the axial through-hole are also restrained proportionally. The internal and external walls of the through-type sleeve are limited to a certain range, making it difficult to make a breakthrough progress in design and innovation of the elastic positioning mechanism. The purpose of the present invention is to provide an innovative through-type sleeve of outstanding practicability.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

Based on the unique configuration of the through-type sleeve of the present invention that a blind chamber is set laterally onto the wrench sleeving end of the main body to accommodate the elastic support and the shelled convex locator, the through-type sleeve of the present invention allows for elimination of the C-shaped clip and recessed ring groove in prior art, thus saving the components and manufacturing process and reducing the manufacturing cost with better industrial benefits.

Based on the configuration of the shelled convex locator, it is possible to reduce substantially or even minimize the assembly space, so as to accommodate itself to the thin-wall through-type sleeve with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an upper perspective view of the through-type sleeve of the present invention.

FIG. 2 shows a partially exploded perspective view of the present invention.

FIG. 3 shows a cross-sectional view of the through-type sleeve of the present invention.

FIG. 4 shows a cross-sectional view of the through-type sleeve of the present invention.

FIG. 5 shows a schematic view of the present invention where the shelled convex locator is recessed under compression.

FIG. 6 shows another schematic view of the wrench sleeving end of the present invention.

FIG. 7 shows the another schematic view of the wrench sleeving end of the present invention.

FIG. 8 shows a perspective view of the main body of the present invention.

### DETAILED DESCRIPTION OF THE INVENTION

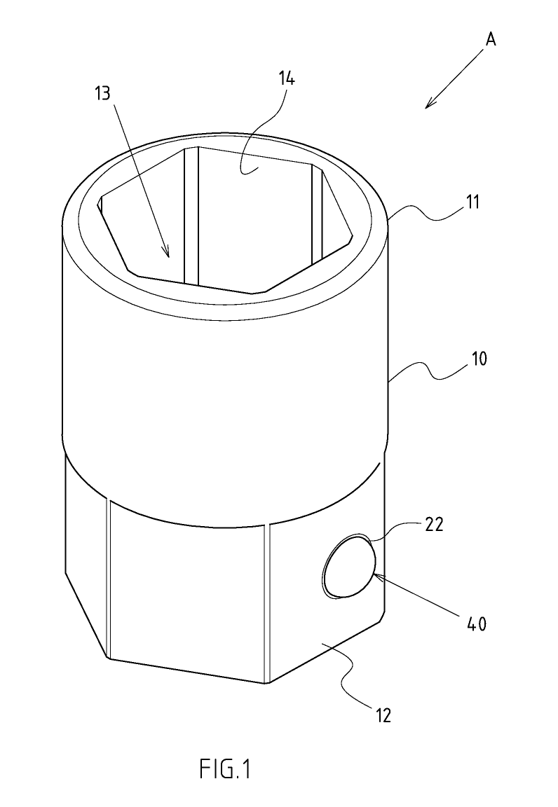

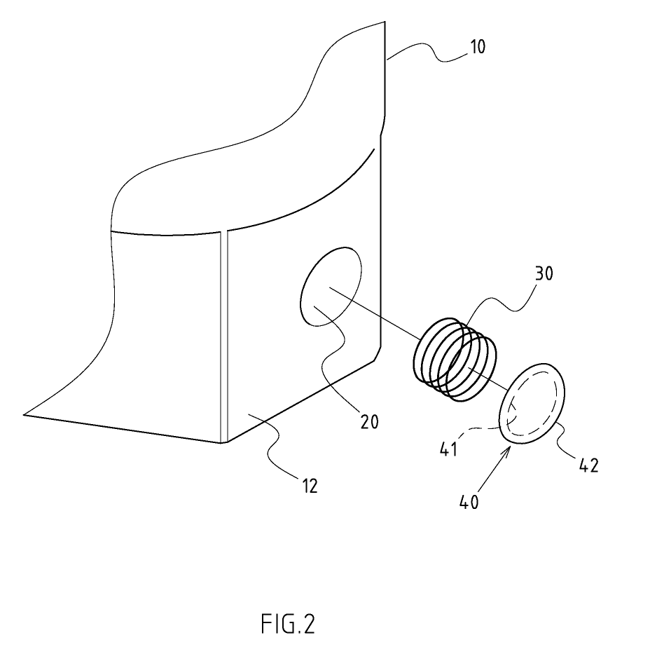

FIGS. 1-4 depict preferred embodiments of a through-type sleeve of the present invention, which are provided for only explanatory objective for patent claims.

The through-type sleeve A includes a main body 10 in a tubular shape. The main body 10 has an actuating end 11 and wrench sleeving end 12. An axial through-hole 13 is set at the center of the main body 10. A moulded groove 14 is set at one end of the axial through-hole 13 correspondingly to the actuating end 11, and a round groove 15 set at the other end of the axial through-hole 13 correspondingly to the wrench sleeving end 12.

A blind chamber 20 is recessed radially at one side of the wrench sleeving end 12 of the main body 10, and provided with an inner wall 21. An elastic support 30 is made of a helical spring, and accommodated into the blind chamber 20.

A shelled convex locator 40 is assembled externally onto the elastic support 30 of the blind chamber 20. The shelled convex locator 40 is provided with an inner face 41 that is supported elastically by the elastic support 30. A convex surface 42 on the shelled convex locator 40 is protruded outside of the blind chamber 20. The protruding state of the shelled convex locator 40 is limited by a limiting portion 22 of the blind chamber 20. The limiting portion 22 is of a punched inner ring flange.

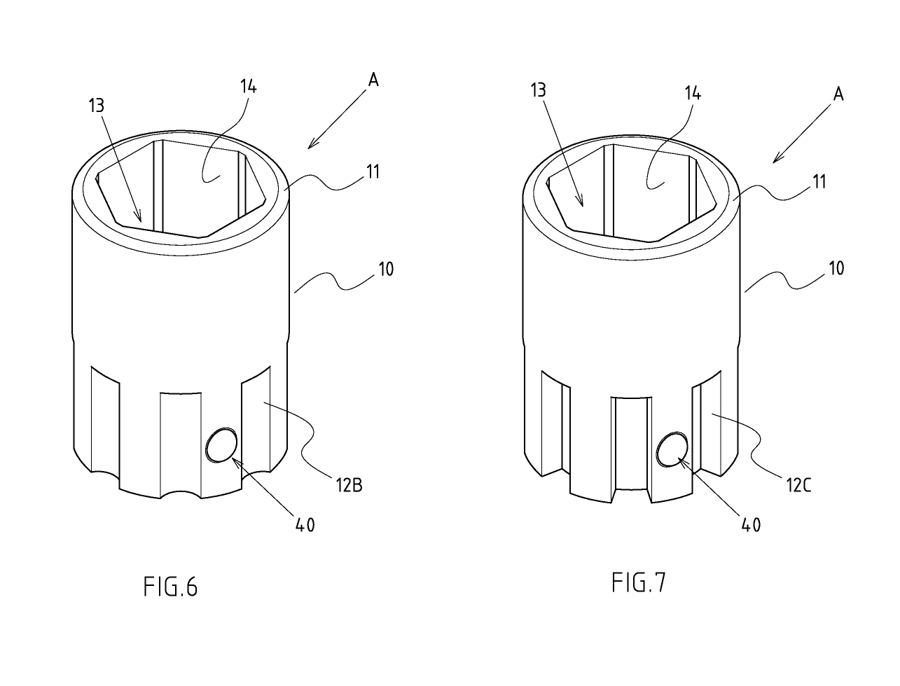

Referring to FIGS. 1-4, the preferred embodiment of the wrench sleeving end 12 of the main body 10 is of a hexagonal pattern. Alternatively, referring to FIG. 6, the wrench sleeving end 12B is of a quincunx pattern. Alternatively, referring to FIG. 7, the wrench sleeving end 12C is of a toothed pattern.

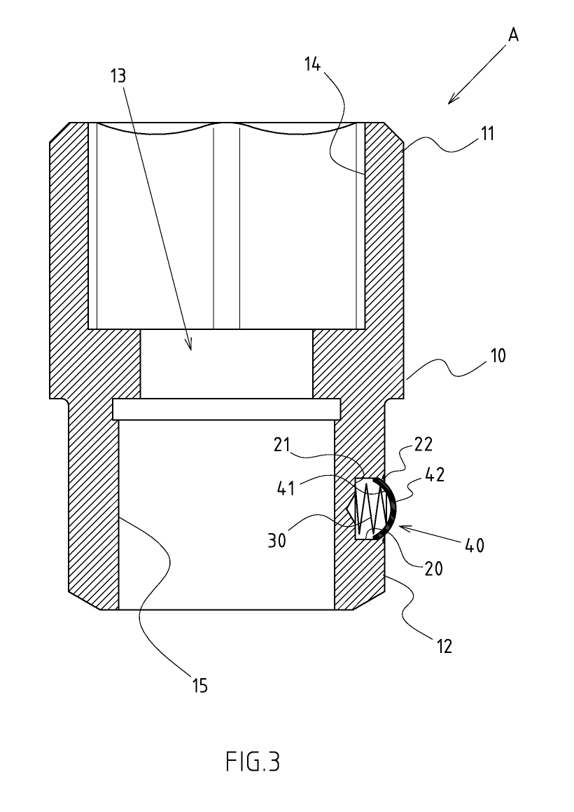

Of which, the inner face 41 of the shelled convex locator 40 is designed into a recessed groove (shown in FIG. 3), or designed into a plane (note: omitted herein).

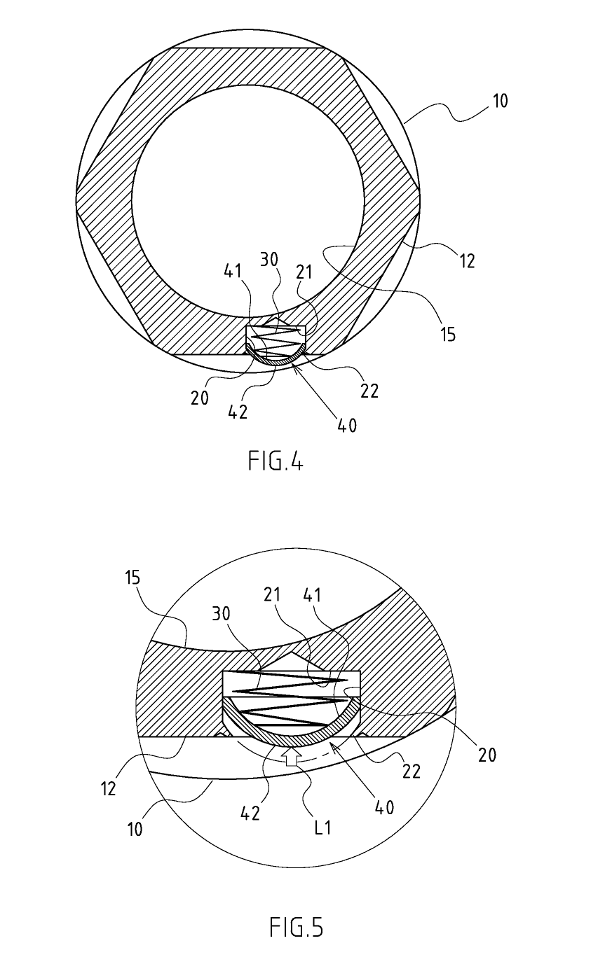

Based on above-specified structural configuration, referring to FIGS. 4 and 5, when the wrench sleeving end 12 of the present invention is used for sleeving of existing wrench, the shelled convex locator 40 of the blind chamber 20 will be recessed under compression (shown by arrow L1 in FIG. 5), then the elastic support 30 will be compressed to accumulate elastic force, so the shelled convex locator 40 could provide an elastic bracing, thus allowing to be mated securely with the wrench sleeving portion.

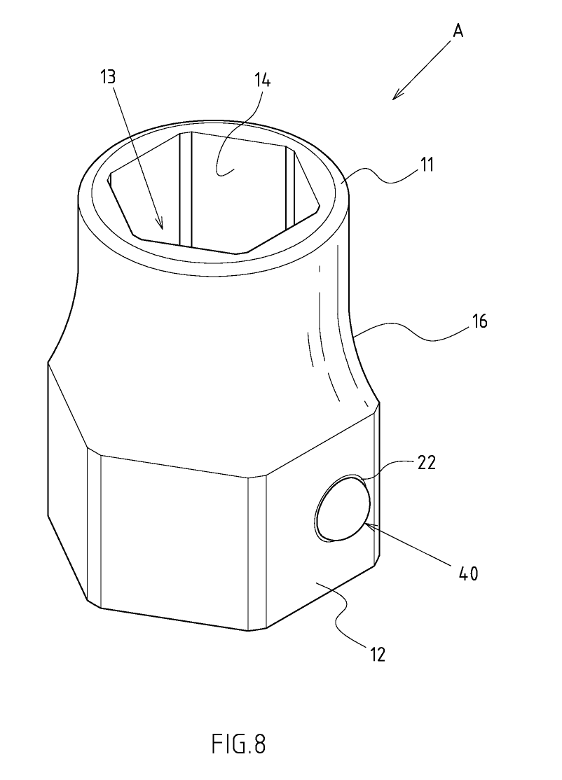

Referring also to FIG. 8, in another preferred embodiment of the main body 10, the external diameter of the wrench sleeving end 12 of the main body 10 is bigger than the actuating end 11, while the wrench sleeving end 12 is coupled with the actuating end 11 via an arched surface 16.

I claim:

1. A through-type sleeve, comprising:
a main body in a tubular shape, further comprising an actuating end and a wrench sleeving end; an axial through-hole is set at the center of the main body; a moulded groove is set at one end of the axial through-hole correspondingly to the actuating end, and a round groove set at the other end of the axial through-hole correspondingly to the wrench sleeving end;
a blind chamber, recessed radially at one side of the wrench sleeving end of the main body, and provided with an inner wall;
an elastic support, accommodated into the blind chamber;
a shelled convex locator, assembled externally onto the elastic support of the blind chamber; the shelled convex locator is provided with an inner face that is supported elastically by the elastic support; a convex surface on the shelled convex locator is protruded outside of the blind chamber; and the protruding state of the shelled convex locator is limited by a limiting portion of the blind chamber.

2. The structure defined in claim 1, wherein the wrench sleeving end of the main body is of either hexagonal, quincunx or toothed pattern.

3. The structure defined in claim 1, wherein the elastic support is a helical spring.

4. The structure defined in claim 1, wherein the inner face of the shelled convex locator is a recessed groove.

5. The structure defined in claim 1, wherein the inner face of the shelled convex locator is a plane.

6. The structure defined in claim 1, wherein the convex surface of the shelled convex locator is an arched surface.

7. The structure defined in claim 1, wherein the limiting portion of the blind chamber is an inner ring flange.
